(19) United States
(12) Patent Application Publication
(10) Pub. No.: US 2015/0317751 A1
(43) Pub. Date: Nov. 5, 2015

(54) Method of Posting Information Regarding Sales Transactions to Social Networks

(71) Applicant: retail2social LLC, Lewes (DE)

(72) Inventors: Charalampos Kalyvas, Varibombi (GR); Angelos Konstantopoulos, Pefki (GR); David-Georgios Trakantzidis, Augsburg (DE); Petros Rellos, Vironas (GR)

(73) Assignee: retail2social LLC, Lewes, DE (US)

(21) Appl. No.: 14/267,880

(22) Filed: May 1, 2014

(51) Int. Cl. G06Q 50/00; G06Q 30/02; G06Q 30/06

(52) U.S. Cl. CPC G06Q 50/01; G06Q 30/0631; G06Q 30/0214

(57) ABSTRACT

A programmed computer having a processor, memory, and a storage medium, said storage medium is disclosed. The storage medium comprises code for receiving an identifier corresponding to a purchaser of a good or service in a retail transaction, data about the retail transaction, and data identifying the good or service, data relating to a social network account associated with the purchaser on a social network, and code for using the social network account to transmit to the social network for display to others a message from the purchaser associating the retail transaction with the purchaser, wherein the message includes information relating to at least one of the retail transaction and the good or service. The system further permits real time scanning or product codes for available discounts, code for retailer recommendation and product promotion.

### BACKGROUND

In the internet age, the effectiveness of traditional methods for advertising retail stores is diminishing as fewer people are watching live linear television programming or otherwise consuming commercial messages. Also, consumers are decreasingly trusting of advertising messages. However, the advent of social networking and the prevalence of smartphones and other mobile devices has created the opportunity to enhance word of mouth advertising by allowing one-to-many recommendations to be disseminated from sources the potential customer trusts, namely his or her friends, relatives, and other acquaintances with whom they have, or have developed, a level of trust. Accordingly, it would be advantageous if a retailer were able to easily allow, and entice, its customers to automatically post information relating to their transactions with the retailer to the customer's social network, in real time after the purchase, at the point of sale, so that the customer's friends and social followers will see that the customer made a purchase from the retailer. Furthermore, it would be advantageous for the retailer to be able to have a line of communication to its customers relating to specific purchases or promoted products.

### SUMMARY OF THE INVENTION

In one aspect of the invention, a programmed computer having a processor, memory, and a storage medium is disclosed. The storage medium comprises code for receiving an identifier corresponding to a purchaser of a good or service in a retail transaction, data about the retail transaction, and data identifying the good or service, data relating to a social network account associated with the purchaser on a social network, and code for using the social network account to transmit to the social network for display to others a message from the purchaser associating the retail transaction with the purchaser, wherein the message includes information relating to at least one of the retail transaction and the good or service. In one aspect of the invention, the storage medium also has code for receiving data identifying a seller of the good or service. In one aspect of the invention, the identity of the seller is also posted to the social network. In one aspect of the invention, the identifier is associated with a loyalty program associated with the seller. In one aspect of the invention, the computer further comprises a product information database, and wherein an item of product information from the product information database is posted to the social network. In one aspect of the invention, the computer further comprises code to maintain metrics relating to the extent to which messages have influenced purchasing decisions.

In one aspect of the invention, a method of posting information is disclosed. The method comprises the steps of scanning a code with a mobile device associated with a purchaser, the mobile device containing a scanner and executable code for performing the scan, wherein the code is associated with a good or service and sending the code or information derived from the code to a platform server to determine whether a promotion for the good or service is active, said platform server comprising a database containing data relating to a social network account associated with the purchaser on a social network. If a promotion for the good or service is active, the method displays a message on the mobile device regarding the promotion, processes user input from the purchaser indicating a desire to purchase the good or service, and uses a social network account associated with the purchaser to post information about the purchaser, the transaction, and the good or service to a social network. In one aspect of the invention, and incentive is provided for the purchase of the good or service.

In one aspect of the invention, a method of posting information is disclosed. The method comprises the steps of requesting user input prior to checkout from an online transaction for a sale of a good or service, regarding whether a user has a type of identifier, if the user does not have the type of identifier, activating a plug-in to connect to a platform server to create an identifier for the user, if the user does have the type of identifier, activating the plug-in to authenticate the identifier with the platform server, transmitting the identifier and data identifying the online transaction and the good or service to the platform server, said platform server comprising a database containing data relating to a social network account associated with the purchaser on a social network; and using the social network account to transmit to the social network for display to others a message from the purchaser associating the online transaction with the purchaser, wherein the message includes information relating to at least one of the retail transaction and the good or service.

In one aspect of the invention, a method of posting information is disclosed. The method comprises the steps of displaying information on a computing device comprising information related to entities whom a user may recommend and a reward for recommending an entity, accepting user input indicating the user's consent to recommend the entity, retrieving from a database at a platform server data relating to an account associated with the user on a social network; and, using the social network account to transmit to the social network for display to others a message from the purchaser recommending the entity.

In one aspect of the invention, a method of posting information is disclosed. The method comprises the steps of displaying information on a computing device comprising information relating to an incentive to purchase a good or service, accepting user input indicating the user's consent to purchase the good or service in exchange for the incentive, processing the purchase of the good or service, retrieving from a database at a platform server data relating to an account associated with the user on a social network, using the social network account to transmit to the social network for display to others a message from the purchaser associating the online transaction with the purchaser, wherein the message includes information relating to at least one of the retail transaction and the good or service, and transmitting a voucher to the user which entitles the user to obtain the good or service.

In one aspect of the invention, a method of posting information to a social network on behalf of a purchaser in a retail transaction with a seller for a good or service is disclosed. The method comprises the steps of receiving at a platform server an identifier belonging to the purchaser, said identifier having been sent to the platform server by a point of sale system, receiving the identity of the seller, the identity of the good or service and transaction information, composing a social network posting to be posted on behalf of the purchaser, the posting containing the purchaser's identity, the identity of the seller, the identity of the good or service, and information relating to the retail transaction, and using the purchaser's credentials on a social network to post the social network posting to the social network.

### BRIEF DESCRIPTION OF THE DRAWINGS

FIG. 1 is a flow diagram of a single direction process with a retail server in accordance with one aspect of the present invention.

FIG. 2 is a flow diagram of a single direction process model with an integrated POS and retail system in accordance with one aspect of the present invention.

FIG. 3 is a flow diagram of a two directional process model in accordance with one aspect of the present invention.

FIG. 4 is a flow diagram of the functionality of the platform for an online retailer in accordance with one aspect of the present invention.

FIG. 5 is a flow diagram of a product promotion process in accordance with one aspect of the present invention.

FIG. 6 is a process flow of a retailer recommendation process in accordance with an aspect of the present invention.

FIG. 7 is a process flow of a pre-discount process in accordance with an aspect of the present invention.

FIG. 8 is a graphical representation of a user data interface in accordance with one aspect of the present invention.

FIG. 9 is a graphical representation of a newsfeed and other functionalities that are available to a user in accordance with one aspect of the present invention.

FIG. 10 is a representation of certifications data in accordance with one aspect of the present invention.

FIG. 11 is a representation of retailer data in accordance with one aspect of the present invention.

FIG. 12 is a more detailed retailer data view in accordance with one aspect of the present invention.

FIG. 13 is a graphical representation of data relating to sales in accordance with one aspect of the present invention.

FIG. 14 is a graphical representation of statistical information available to retailers in accordance with one aspect of the present invention.

FIG. 15 is a graphical representation of data representing demographic profiles of the users of the platform who buy, want or own their products, or who follow their business in accordance with one aspect of the present invention.

FIG. 16 is a graphical representation of user or retailer registration on the platform in accordance with one aspect of the present invention.

FIG. 17. is a graphical representation of a product page in accordance with one aspect of the present invention.

FIG. 18. is a graphical representation of a retailer offers list in accordance with one aspect of the present invention.

FIG. 19 is a graphical representation of pre-discount offers in accordance with one aspect of the present invention.

FIG. 20 is a graphical representation of retailer recommendations in accordance with one aspect of the present invention.

FIG. 21 is a graphical representation of loyalty programs hosted on the platform in accordance with one aspect of the present invention.

FIG. 22 is a graphical representation of how the retailer, brand and manufacturer enter and publish their offers on the platform in accordance with one aspect of the present invention.

### DETAILED DESCRIPTION OF THE INVENTION

In accordance with one aspect of the invention, a platform for promotion of retail sales and/or data capture and management is created. The platform has one or more servers (“platform servers”) which perform the various functions of the platform as disclosed herein. The platform has a number of users, or customers, who are given an identifier (e.g., a membership number) when they agree to participate in, and become users of, the platform. The user can obtain an identifier in a number of ways known in the art, including clicking on a digital link, typing a link received on a physical item, e.g. a piece of paper, downloading a mobile application associated with the platform, or scanning a code, e.g. a QR code, leading to the registration pages. The platform has its own user interaction component and also interfaces with social networks.

In accordance with one aspect of the present invention, a direct link is established between the actual physical retail store point of sale and/or e-shop checkout and the platform server which then posts sales transaction details in real time on the platform and social media platforms and/or digital media. The invention, in accordance with one aspect, is ultimately a link between the physical retail store point of sale and/or e-shop checkout and the social world. In one aspect of the invention, the invention can be deployed without any new hardware or software on the retailer's end, or, in another aspect, it can be deployed with the same hardware and small modifications to the retail software.

In accordance with one aspect of the present invention, the platform allows actual buyers who purchased a particular product or service to communicate with their friends, family and public on all aspects related to their purchase and also allows the vice versa—a potential purchaser can directly or indirectly communicate with other users of the platform regarding an intended or motivated purchase, or just to be informed.

In accordance with one aspect of the present invention, the platform is dedicated to the publication and provision of discounts and incentives intended to motivate purchases of products and services, as well as a focus on the sharing of information related to products or services on offer, as well as information related to the actual purchase and sale of products and services. This information can include many details related to the product or service, including actual sales transaction data, product/service specifications/details, reviews, buyer experience, likes, dislikes, wants, ideas, offers, opinions and other information without limitation. This information can be seen or monitored through the platform itself and/or on other social media platforms by any brand owner, retail/chain store, user or friend of the user on the platform or the social network where the information is posted. In addition to the above the platform provides real-time analytics about user engagement and user reach on any particular sales transaction and generates reports to support decision making by the end purchaser as well as the retailer. The platform also allows the retailer or brand owner to measure the success of a particular promotion. In one aspect of the invention, the platform will provide metrics to the retailer or brand/manufacturer, which will define how much a friend or family member influenced the purchaser on the buying decision.

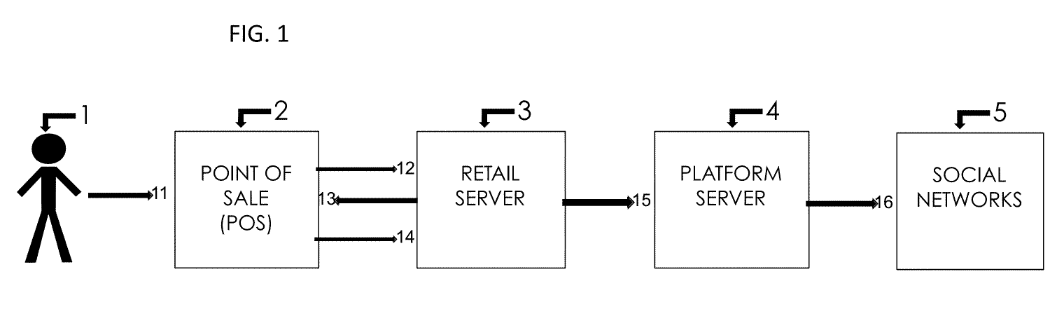

Turning to FIG. 1, a flow diagram of a single direction process with a retail server in accordance with one aspect of the present invention is shown. In step 11 the user 1 reaches the cashier (not shown) who is operating a Point of Sale (“POS”) terminal 2 such as a register (hereinafter, a “POS operator”) at a retail store to make a purchase and he/she gives his/her unique identifier, for example, in the form of a virtual card, a physical card and/or any type of identification documentation or membership card linked to the platform. The POS operator authenticates the user by reviewing his/her identifier and enters the user's identifier in a designated input space of the POS. In step 12 the POS transmits the identifier to the retailer's retail server 3 and the sale transaction is recognized by the retail server as a transaction associated with the platform. For the purposes of this application, a “retail server” is any machine used by the retailer to perform the functions typically associated with an Enterprise Resource Planning (“ERP”) server, such as processing transactions, inventory, etc.

Because a transaction is associated with the platform, in step 13 appropriate discounts and/or incentives are applied to the items which the user wishes to purchase when the POS operator scans and/or rings them up. The POS operator scans and/or rings up the items that the purchaser wishes to purchase and advises the purchaser of the purchase amount (which includes the discount/incentive of the platform), payment is made and the transaction is finalized at the POS. At step 14 the details of the sale transaction are transmitted from the POS and stored on the retailer's retail server. In step 15, the retail server transmits the sales transaction details to the platform server 4. For the purposes of this application, the “platform server” is a server that is used by the operator of the platform to run the functions of the platform as described herein. The transaction details that are sent to the platform server include but are not limited to the user identifier, store number, date and time of transaction, product code, product description, pre-discount/incentive discount price and discount/incentive. This transmission, in one aspect, happens within approximately five minutes, though other intervals of time could be used. In one aspect of the invention, data is sent to the platform server in an aggregated format every five minutes, instead of separately every transaction, in order to avoid overloading the server. However, shorter or longer intervals could be used, and real-time non-aggregated transmission can also be used.

The platform server then processes this information and adds additional information from its product information database such as, but not limited to, picture of product, specs and other. In step 16, the platform server posts the sales transaction data in real time on behalf of the purchaser on the purchaser's social network profiles and/or newsfeeds 5. Social networking information for the purchaser has already been stored at the platform server as a condition of the purchaser receiving his identifier to join the platform, and permission has been granted to the platform to post to the social networks on the purchaser's behalf. Post to one or more social networks may be accomplished with the use of the Application Program Interface (“API”) of each respective social network. Accordingly, the platform, in one embodiment, does not have access to the user's password, but knows the user's user ID and has been granted permission by the user, e.g. during the registration process for the platform, to perform certain actions on the social network on behalf of the user, e.g. post certain types of messages.

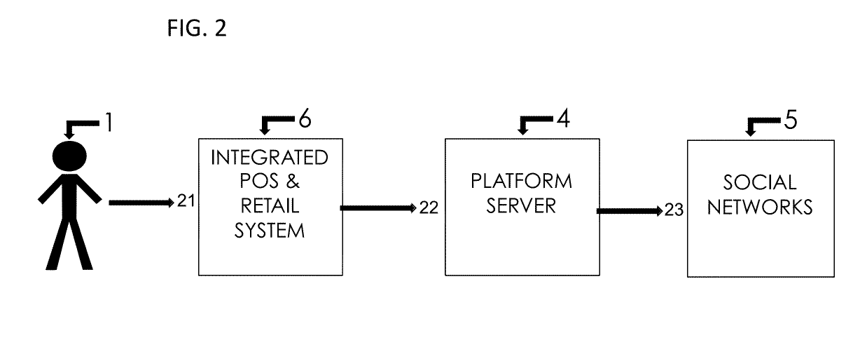

Turning to FIG. 2, a flow diagram of a single direction process model where the retail server integrated with the POS in an integrated system 6 is shown in accordance with one aspect of the present invention. In step 21 the purchaser 1 reaches the POS operator to make the purchase and gives the POS operator his or her identifier, similarly as discussed in reference to FIG. 1. The POS operator authenticates the user by reviewing his/her identifier and enters his identifier in a designated input space of the POS. The integrated system recognizes the sale transaction as a transaction associated with the platform. The POS operator scans and/or rings up the items that the purchaser wishes to purchase and advises the purchaser of the purchase amount (which includes the discount/incentive), the appropriate discounts/incentives are applied, payment is made and the transaction is finalized at the POS/retail system. Persons having ordinary skill in the art will realize that the order of these steps is not essential to the operation of this aspect of the invention, in that, by way of example, the items can be scanned and/or rung up before the identifier is entered.

The details of the sale transaction are then stored on the retailer's integrated system. In step 22, the retailer's integrated system transmits the sales transaction details to the platform server 4 which may include (without limitation) the purchaser's identifier, a store number, date and time of transaction, product code, product description, pre discount/incentive discount price and discount/incentive. The platform server processes this information and adds additional information from its database such as, but not limited to, picture of product, specs and other. In step 23, the platform server then posts the sales transaction data in real time on behalf of the platform user on the user's social networks profiles 5 as discussed with reference to FIG. 1.

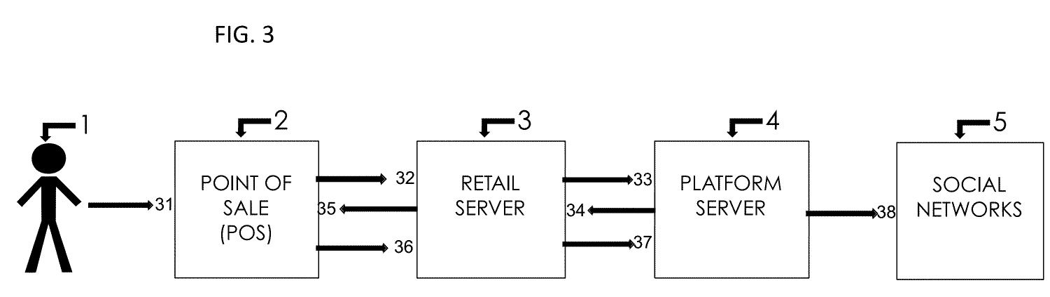

Turning to FIG. 3, a flow diagram of a two directional process model in accordance with one aspect of the present invention is shown. In step 31, the purchaser 1 reaches the POS operator 2 to make the purchase and presents the user identifier. The POS operator enters the identifier in the POS interface. In step 32, the POS transmits the identifier to the retail server system 3 for authentication. In step 33, the retail server system transmits the identifier to the platform server 4. In step 34, the platform server authenticates the identifier and if authentication is successful it then transmits an approval message to the retailer server system. In step 35, the retailer server system transmits an approval authentication message to the POS which allows the POS operator to proceed with the sales transaction based on discounts/incentives relating to the platform. The POS operator completes the transaction as discussed above.

In step 36, the details of the sale transaction are transmitted from the POS and stored on the retail server. In step 37, the retail server transmits the sales transaction details to the platform server which may include, without limitation, the purchaser's identifier, store number, date and time of transaction, product code, product description, pre-discount/incentive discount price and discount/incentive. The platform server processes this information and adds additional information from its product information database such as, but not limited to, picture of product, specs and other. In step 38, the platform server then posts the sales transaction data in real time on the user's social networks 5 as discussed in reference to FIG. 1.

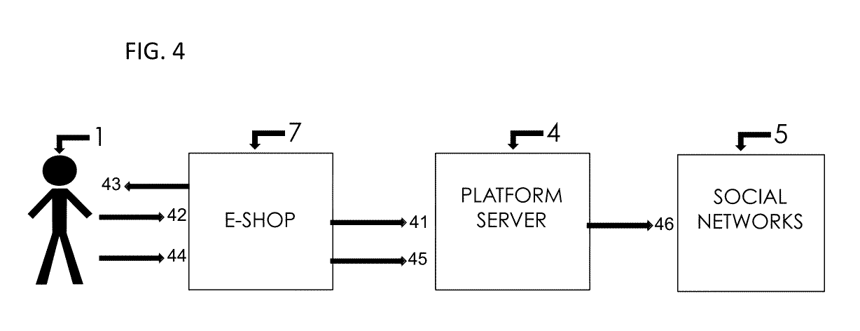

Turning now to FIG. 4, a flow diagram of the functionality of the platform for an online retailer in accordance with one aspect of the present invention is shown. A plug in/module is created for online retailers to install to permit the online retailer to interact with the platform and the platform server. In step 41, the owner/business administrator of the e-shop 7 creates a business account with the platform and installs the plugin module. The online retailer is then enabled to interact with the platform and may provide discounts and incentives to users having identifiers associated with the platform. The above procedure, makes the online retailer's point of sale visible to the users of the platform as well. In step 42, a customer of an online retailer 1 selects his/her products, places them in the cart or “e-basket” and proceeds to the e-shop checkout. In step 43, the purchaser is asked if he is an existing member of the platform or if he wishes to become one, and enjoy discounts and/or incentives.

In step 44, if the shopper is an existing member he enters his identifier and is authenticated by the platform server. In one aspect, the user's platform credentials may be saved on the user's device, making authentication automatic. If the e-shopper is not a member and wishes to become one he is redirected on a new pop up window where he enters his/her details and secures his/her identifier. The checkout is then completed with the application of the platform discounts and/or incentives, the shopper pays and the transaction is finalized. In step 45, the online retailer's server transmits the sales transaction details to the platform server. The platform server 4 processes this information and may add additional information from its database. In step 46, the platform server then posts the sales transaction data in real time on behalf of the user on the user's social networks 5 in the same way as disclosed above with respect to brick and mortar transactions.

In accordance with one aspect of the invention, a retailer may wish to integrate an existing or new loyalty program with the platform. In this case, loyalty program members can become members of the platform upon divulging their social networking details, and can use their existing loyalty identifier as their platform identifier. This permits a retailer's customer to use his or her existing retailer loyalty identifiers to receive discounts and other incentives from the platform resulting in purchase transactions or point redemption transactions and the posting of details of such transactions on the social networks of the retailer's customer as shown in FIGS. 1, 2, 3 and 4. Multiple loyalty identifiers, for multiple retailers, can be associated with a given platform account. Additionally, the retailer can choose to accept the platform identifier as a loyalty membership identifier. This permits a retailer to use the platform as its own loyalty program to track the spending habits of its customers, to communicate with them, to provide them with information on incentives and rewards and to generally to motivate the use of the loyalty card to increase sales and customer retention.

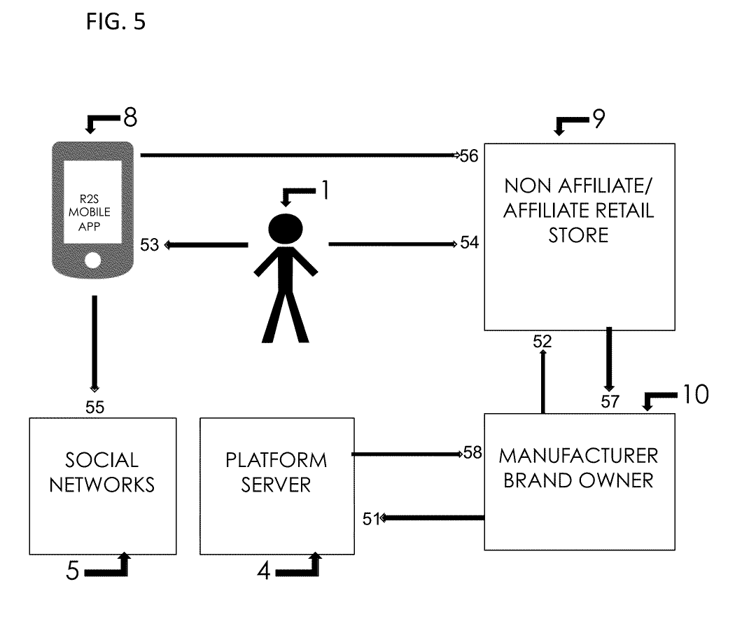

Turning now to FIG. 5, where a flow diagram of a product promotion process in accordance with one aspect of the present invention is shown. In step 51, the manufacturer/brand owner 10 of a product becomes associated with the platform and provides a list of products with their EAN/UPC codes and/or QR codes, product name, description, specifications, normal price, discounted price, picture and locations which they wish to promote via the platform. In step 52, the manufacturer communicates the product promotion to his retailers (whether affiliated with the platform or not) 9 and provides details as to which products will be promoted via the platform and when. In step 53, the user 1 downloads and installs a software application on a mobile device to interact with the platform 4. The software application has a QR/EAN/UPC reader function as well as a product ID field for manual typing of the EAN/UPC code. If the customer is not associated with the platform, he/she can register via the mobile application.

In step 54, the user 1 enters a retail store in order to purchase the manufacturer's/brand owner's product. In step 55, before moving to the checkout counter the user uses the mobile application and scans the product EAN/UPC/QR code which appears on the product packaging or inserts the product ID manually. The platform will advise the user via message on his mobile screen what product he/she has scanned and what discount is offered and asks him/her to confirm if he/she wishes to purchase it. As soon as the user confirms that he/she will purchase the product, the transaction/purchase information is automatically posted on the user's selected social networks 5 (as discussed above), and the user also receives the discount code which in step 56 the user gives to the check out/point of sale in order to obtain the discount. In step 57, retail store 9 (whether affiliated with the platform or not) stores the discount code and related discount amount and presents same to the manufacturer 10 at the end of the month for a credit or cash payment, in the manner of a traditional manufacturer's coupon. In step 58, the manufacturer/brand owner 10 is also able to validate/cross check every discount code presented by the retailer for payment/reimbursement via the platform. All the transaction data is stored on the platform 4 for the manufacturers' use and processing.

In one aspect of the invention, the product promotion can also be used as a type of product lottery whereby the manufacturer/brand owner is substituted by a lottery company which sells product lottery tickets which then entitle the ticket holder to scan certain products in selected retailers and obtain a discount of 10% up to 100%. In this aspect, the process followed is exactly the same as above with the only difference that in order to redeem the lottery prize the user has to enter the lottery ticket number and answer a secret question to validate that he did in fact purchase a product lottery ticket.

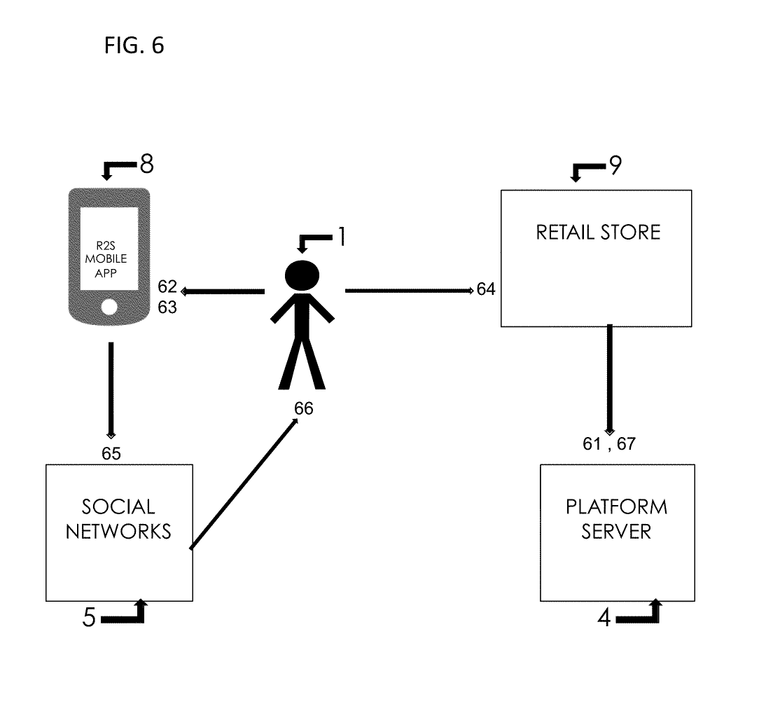

Turning now to FIG. 6, where a process flow of a retailer recommendation process in accordance with an aspect of the present invention is shown. In step 61, the retailer 9 registers on the platform and purchases recommendation credits. In step 62, a user 1 downloads the mobile application of the platform 4. In step 63, the user can see via the mobile or computer application which stores have subscribed for retailer recommendation credits, where they are located and what amount the user will earn from recommending such retailer via the platform. In step 64, the user 1 enters the store 9 that has subscribed for recommendation credits and executes a retailer recommendation via the user interface of the mobile application. In step 65, immediately upon doing so, the user's 1 recommendation is posted automatically on the user's selected social networks 5. In step 66, the value of the recommendation is credited to the user's account which is displayed on the user interface of the mobile application and the computer application or internet site. When the total value of recommendation reaches a threshold, the user 1 receives money or other incentives. In step 67, the retailer who has purchased recommendation credits can see how many users have made a recommendations in their store, they can see what money they have spent to generate recommendations within their store and the remaining balance of their recommendation credit account.

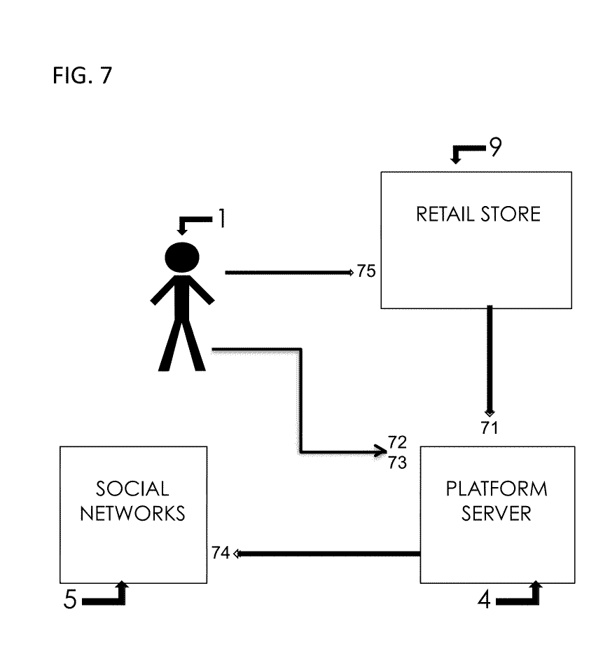

Turning now to FIG. 7, where a process flow of a pre-discount process in accordance with an aspect of the present invention is shown. In step 71 a store 9 that is affiliated with the platform provides a list and info of products which it wishes to promote via the platform 4 by purchasing a pre-discount. Such information can include product pictures, price, discount price, specifications, bar codes, product codes, etc. Virtual product discounted coupons are created and displayed on the stores 1 profile pages on the platform 4 for review and purchase by a user 1. In step 72, a user 1 views the various virtual product discounted coupons on the platform 4 and in step 73 purchases the product which he/she chooses with the advertised discount. In step 74, immediately upon the purchase of the product via the virtual product discounted coupon, the transaction/purchase data are posted automatically by the platform on the user's selected social networks 5. In step 75, the user 1 goes to the physical store 9 and presents his virtual product discounted coupon, either printed from the platform or displayed on an electronic device carried by the user, together with identification documents, and collects the purchased product.

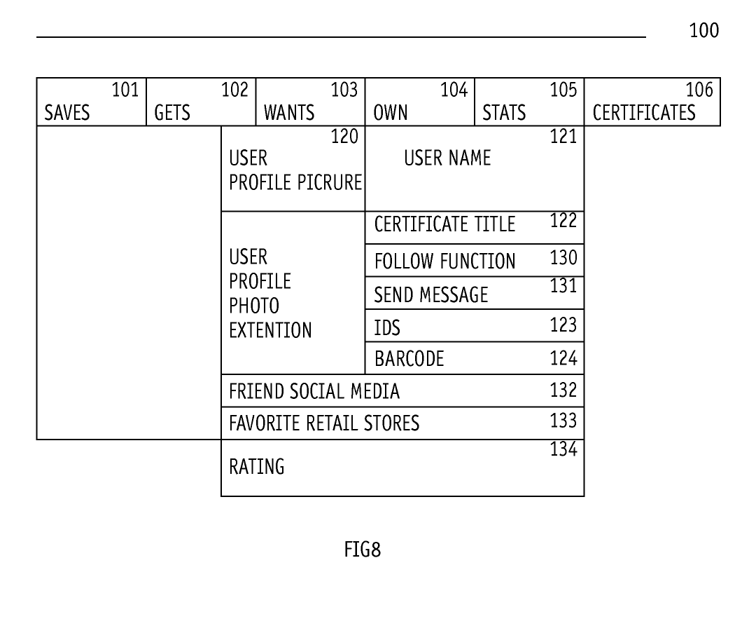

Turning now to FIG. 8, a graphical representation of a user data interface in accordance with one aspect of the present invention is shown. The data structure shown in FIG. 8 shows the user information, including an amount of money saved using the platform 101, a list of transactions 102, a list of items the user wants to buy 103, a list of items the user has purchased without using the platform 104, a user profile picture 120, a user name 121, a list of the user's IDs (e.g. loyalty program ID as discussed above) 123, the user's friends on the user's other social networks 132, and the products the user has rated 134. The user can also send messages to other users 131. The user interface may also include stats 105, barcodes 124, and favorite retail stores 133. The user can also achieve various levels of certification based on his/her activity on the platform 106 and each certificate carries a distinct title which is visible to the user and his followers 122. The user can also follow other users of the platform by using the follow function 130. In addition a graphical representation of a newsfeed 110 is shown.

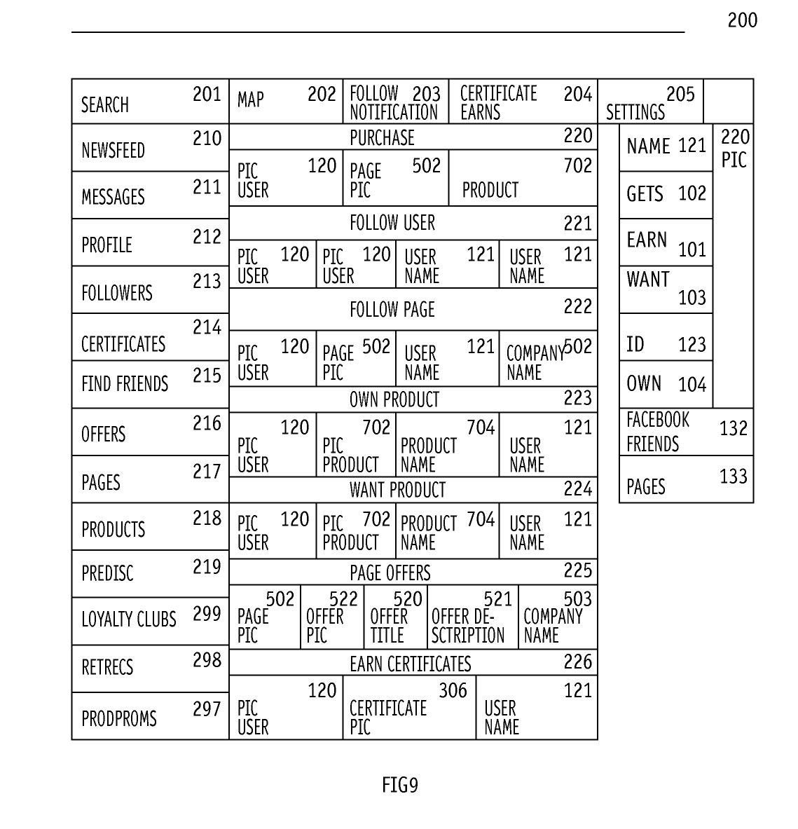

Turning now to FIG. 9, a graphical representation of a newsfeed 200 is shown. Various user interface and data elements are shown in FIG. 9 including messages 211, a find friends interface 215 which in one aspect can link to the user's other social networks, and displayed data relating to products the user owns 223 or wants 224 as well as followings of a particular user 221 or retailer, brand, or manufacturer 222. The newsfeed may also show search 201, newsfeed 210, profile 212, followers 213, certifications 214, offers 216, pages 217, products 218, map 202, follow notification 203, badge earn 204, settings 205, pic user 120, page pic 502. The newsfeed may also show the purchase transactions made by users of the platform 220, with one or more details of the transaction. Offers made by retailers on the platform 225 may also be shown. Users can also view the pre-discounts 219 as discussed in reference to in FIG. 7, as well as details relating to the retailer loyalty clubs 299 to which the user is is a member as discussed above. The retailer recommendation function 298, as discussed in reference to FIG. 6 above, and the Product promotions 297 referred to in FIG. 5 above are also shown. Certifications earned or upgraded 226 are visible on the newsfeed.

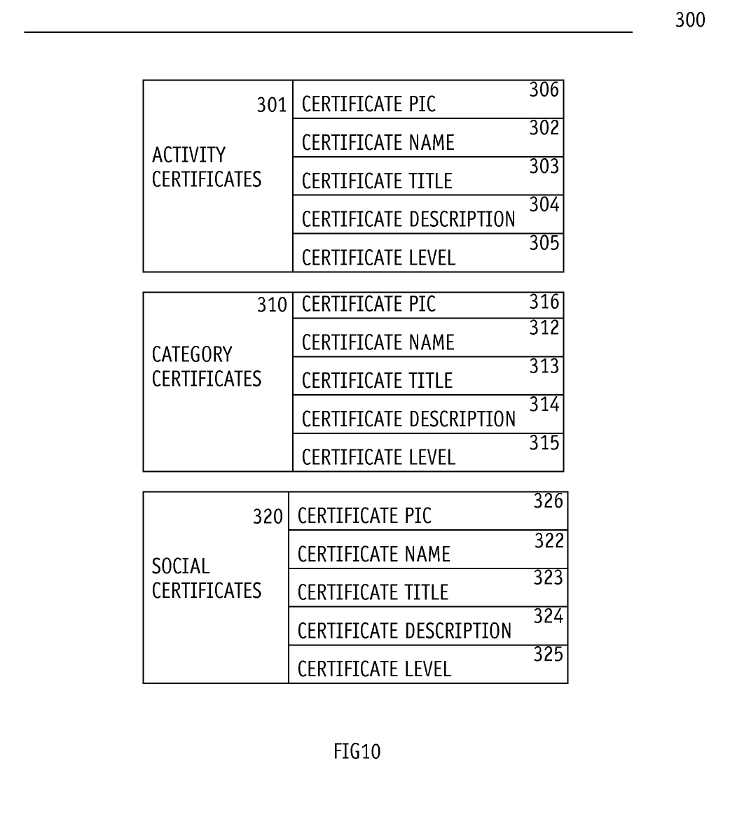

Turning now to FIG. 10, a representation of certifications data is shown. Activity certifications 301 has a picture 306, a name 302, a title 303, a description 304 and a level 305. Similarly, Category certifications 310 and Social certifications 320 are shown having the same fields as Activity Certifications 301, including a picture 316, a name 312, a title 313, a description 314 and a level 315 for Category certifications and a picture 326, a name 322, a title 323, a description 324 and a level 325 for Social certifications. Activity certifications are based on how active the user is in the platform. Other certifications can be awarded for numbers of transactions and reputation for accurate or informative reviews.

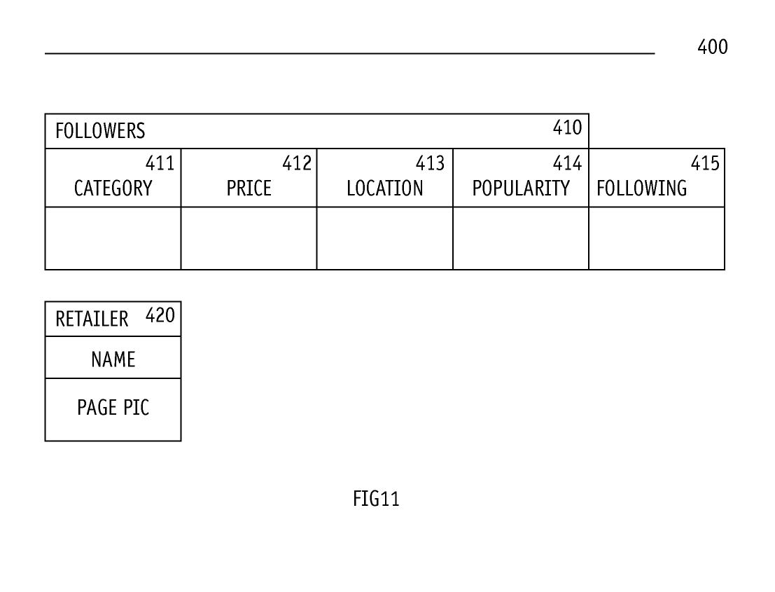

Turning now to FIG. 11, a representation of filters 410 and retailer name and profile picture 420 are shown. The user can filter when searching for retailers according to Category 411, Price 412, Location 413, Popularity 414 & Following 415.

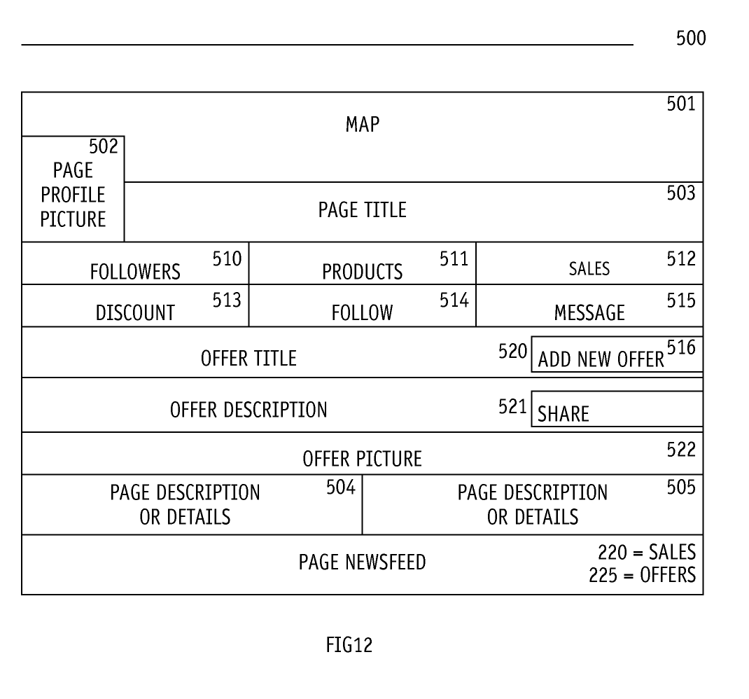

Turning now to FIG. 12, a more detailed retailer data view 500 is shown. Data relating to a map 501 is shown. Furthermore, the retailer can have followers shown 510, and can display its sales 512. The retailer detail view can also show a page profile picture 502, a page title 503, products 511, discounts 513, a link to follow the retailer 514, a link to send the retailer a message 513, one or more offer titles 520, one or more offer descriptions 521, an offer picture 522, page description or details 504, 505, and a page newsfeed which shows purchases 220 made by users from the retailer using the platform as well as offers 225 provided by the retailer to the platform user. The retailer is able to enter new offers by using the add new offer function 516.

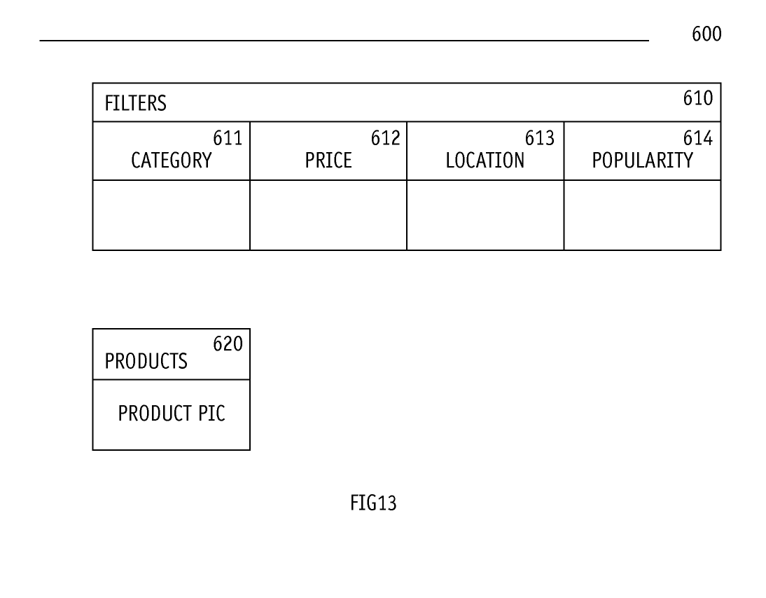

Turning now to FIG. 13, a representation of filters 610 and Product name and profile picture 620 is shown. The user can filter when searching for products according to Category 611, Price 612, Location 613, Popularity 614.

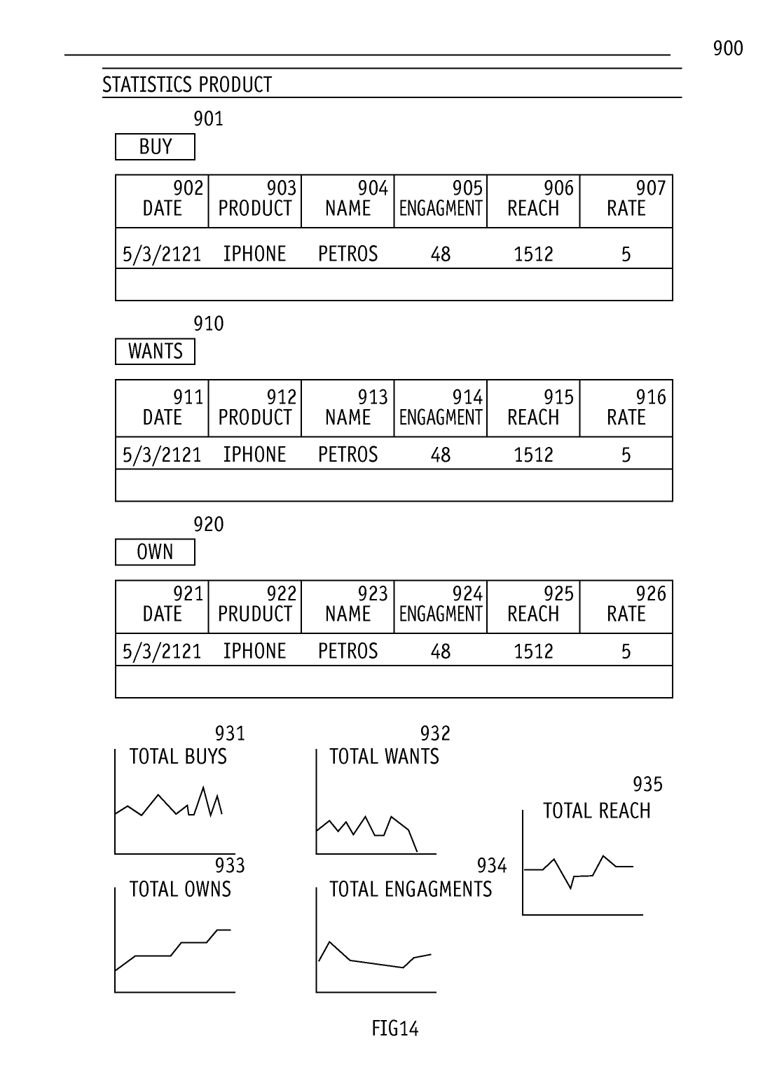

Turning now to FIG. 14, retailers can see statistical representations of what benefit they are receiving from participating in the platform. The retailer can see sales generated by the platform 901, product wants by users of the platform 910 or products owned by users of the platform 920, including information about the date 902, 911, 920, the product 903, 912, 922, the name of the user 904, 913, 923, and statistics on engagement 905, 914, 924, the reach of the post 906, 915, 925 and the rate 908, 916, 926. The platform can keep and display data which can be displayed as line graphs over time, relating to total buys 931, total wants 932, total owns 933, and total reach 935 and total engagement 934.

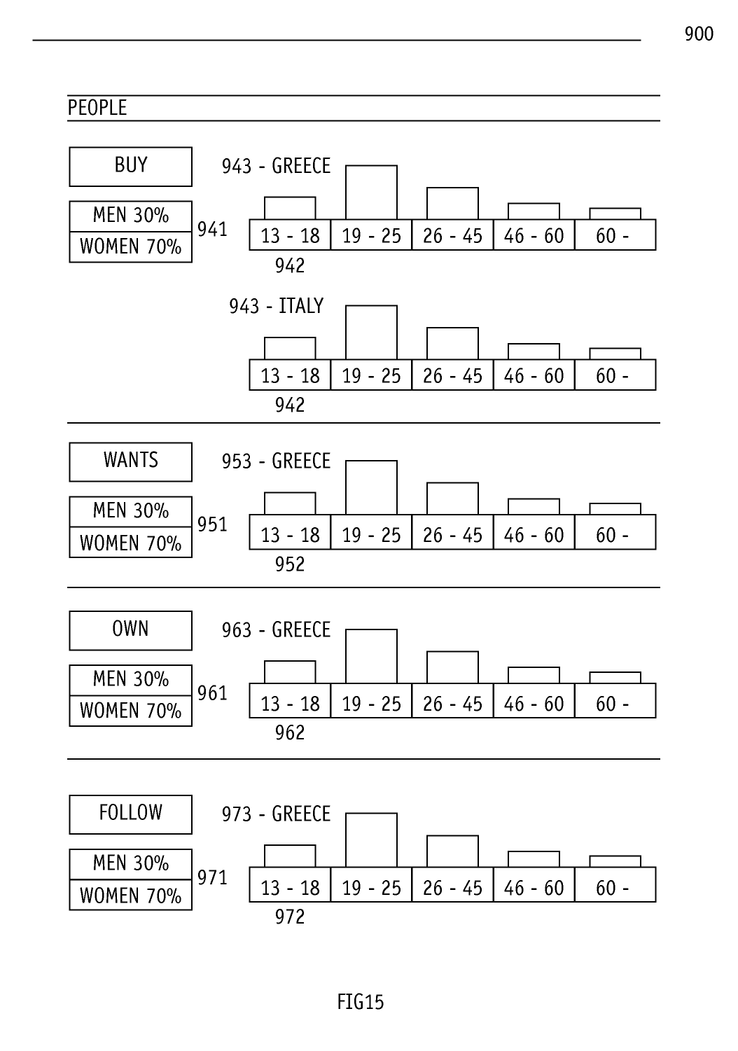

Turning now to FIG. 15, retailers can see data representing demographic profiles of the users of the platform who buy, want or own their products, or who follow their business. Through the platform, retailers can view statistics regarding users who have purchased items from them via the platform 940, who have marked one of their products as something they “want” 950 or as something they own 960, or those who “follow” them on the platform 970. Users can see demographic information including gender 941, 951, 961, 971, age 942, 952, 962, 972 or country 943, 953, 963, 973.

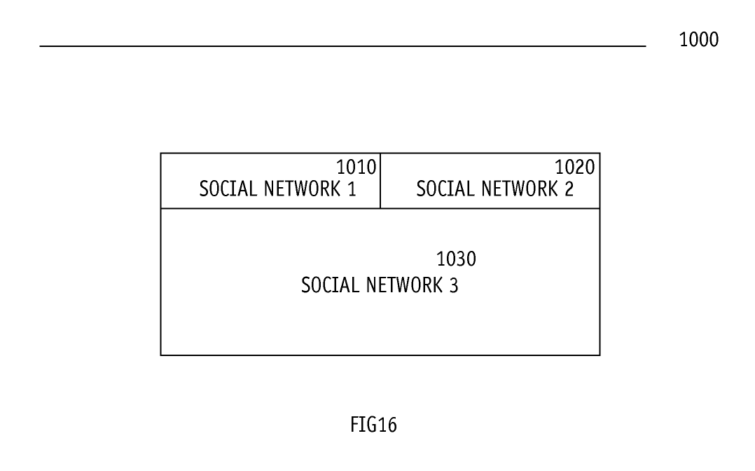

Turning now to FIG. 16, retailers, manufacturers and users can register 1000 on the platform using the common social network “connect” feature 1010, 1020, 1030. In one aspect the user can register to post on more than one social network.

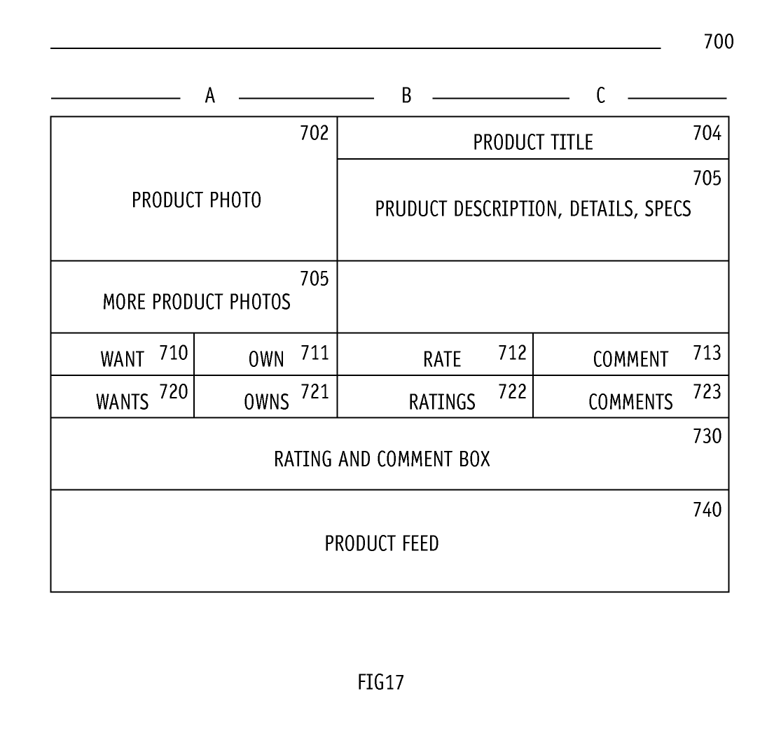

Turning to FIG. 17, retailers, manufacturers and users can view details of products such as Product photo 702, product title 704, product description, details, and specifications 705, and more product photos 706. The user can add the product to their want list 710, or see other users who want the product 720. The user can add the product to their “own” list 711 and see other who own it 721. Users can rate the product 712 and see other ratings 722. Users can comment 713 and see other comments 723. In addition ratings and comments can be entered in the rating and comment box 730 and product comments and ratings appear on the product feed 740.

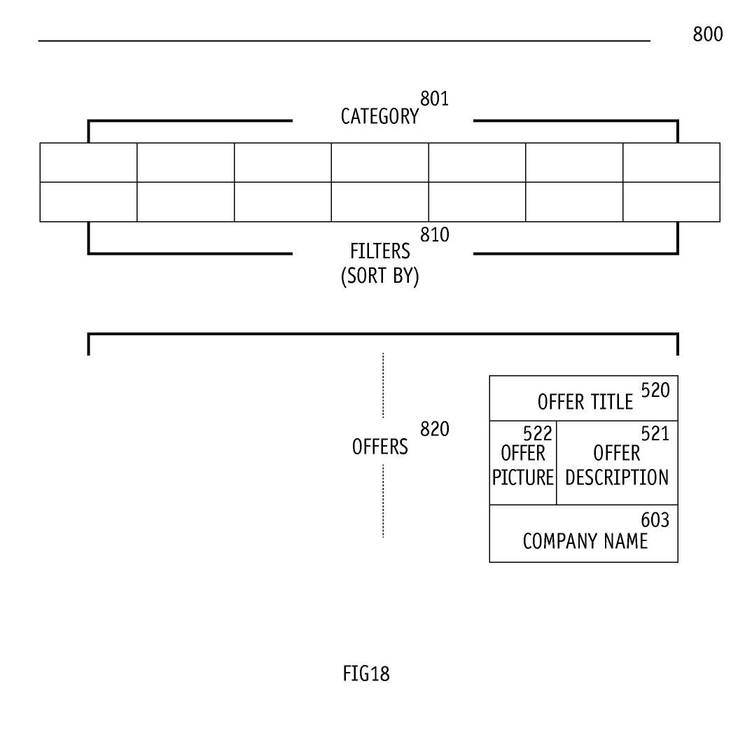

Turning to FIG. 18, retailers, manufacturers and users can view offers being made available by retailers or manufacturers, and search by category 801, sort or filter 810, view offers 820. Offers can be viewed in detail with offer title 520, offer picture 522, offer description 521 and offer company name 603.

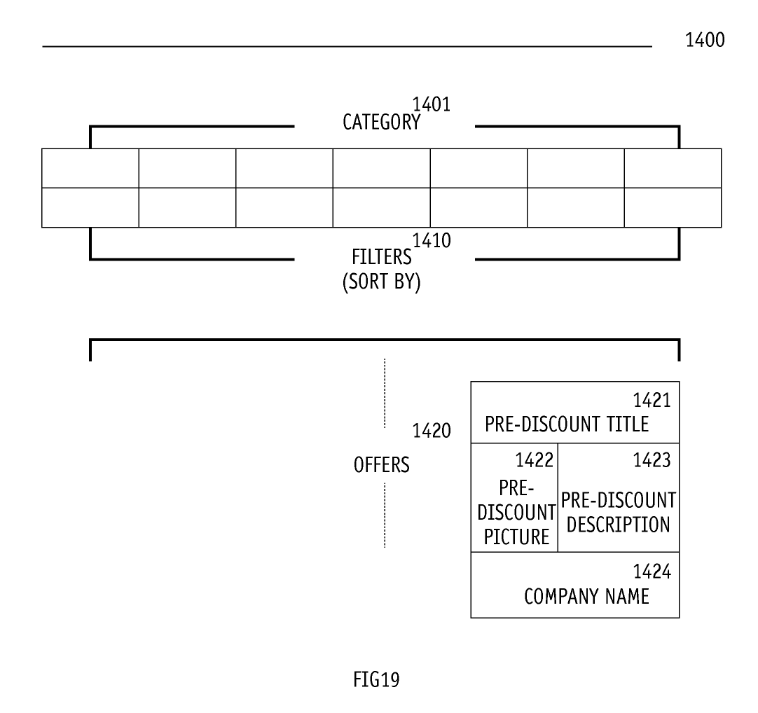

Turning to FIG. 19, retailers, manufacturers and users can view pre-discount offerings by retailers or manufacturers, and search by category 1401, sort or filter 1410. Offers can be viewed in detail 1420 with pre-discount title 1421, pre-discount picture 1422, pre-discount description 1423 and offer company name 1424.

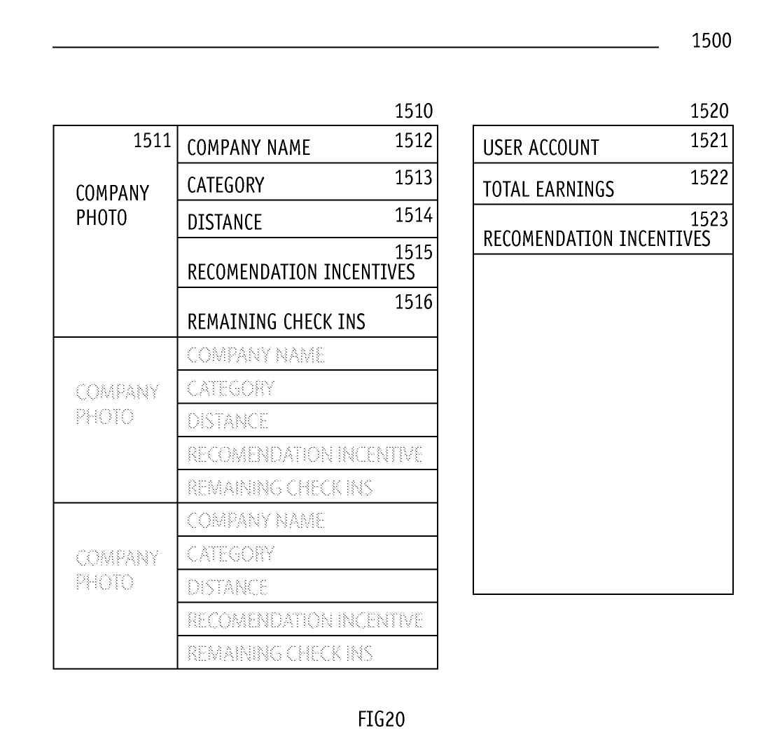

Turning to FIG. 20, retailers and users can view the retailer recommendation page with details such as Retailer photo 1511, Retailer name 1512, Category 1513, Distance 1514 (e.g., from a current location), recommendation incentive 1515 and Remaining retailer recommendations 1516. In addition the user can view his/her user account 1521, total earnings 1522 and total retailer executed recommendations 1523.

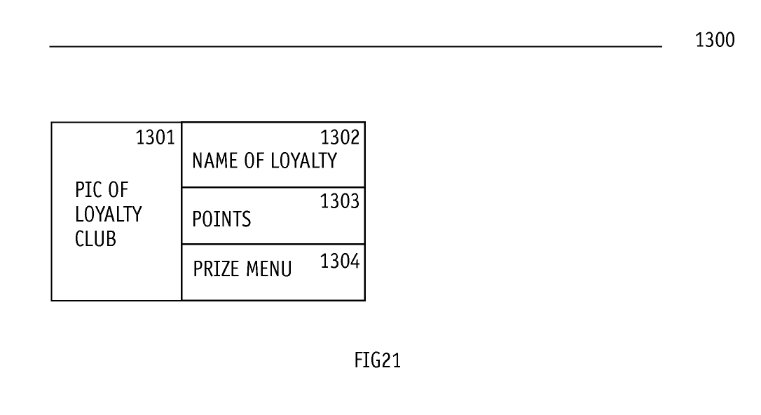

Turning to FIG. 21 users can view loyalty programs and clubs they have joined 1300 with details such as picture of loyalty program 1301, name of loyalty program 1302, loyalty points earned 1303 and loyalty prize menu 1304.

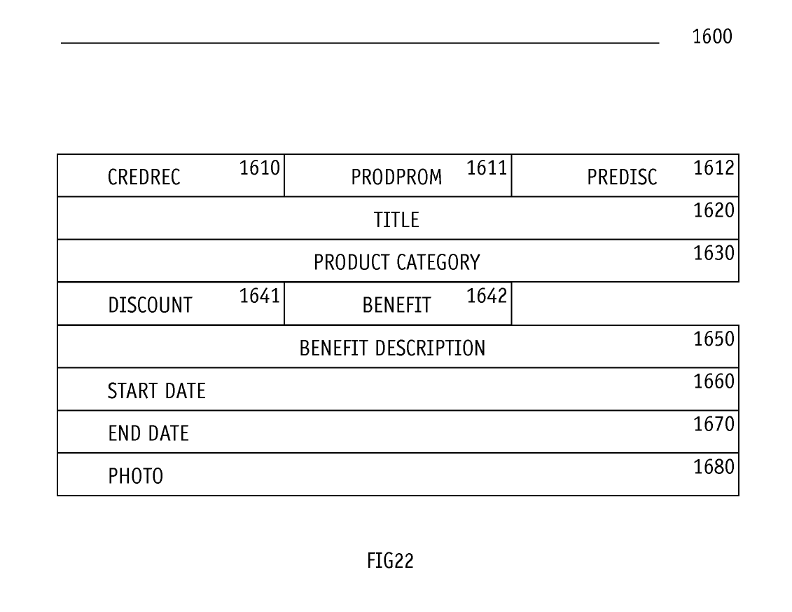

Turning to FIG. 22 users can view the entering of offers 1610, 1611, 1612 by the retailer, brand owner and manufacturer on the platform. The retailer, brand owner and manufacturer can select between different categories of offers 1610, 1611, 1612 and can specify offer title 1620, product category 1630, offer discount 1641, benefit 1642, benefit description 1650, offer start date 1660, offer end date 1670 and photo 1680.

Persons having ordinary skill in the art will understand that the invention can be modified and expanded to allowing for further interaction between retailers and social networks.

What is claimed is:

1. A programmed computer having a processor, memory, and a storage medium, said storage medium comprising:
a. code for receiving an identifier corresponding to a purchaser of a good or service in a retail transaction, data about the retail transaction, and data identifying the good or service;
b. data relating to a social network account associated with the purchaser on a social network; and
c. code for using the social network account to transmit to the social network for display to others a message from the purchaser associating the retail transaction with the purchaser, wherein the message includes information relating to at least one of the retail transaction and the good or service.

2. The computer of claim 1, further comprising code for receiving data identifying a seller of the good or service.

3. The computer of claim 2, wherein the identity of the seller is also posted to the social network.

4. The computer of claim 2, wherein the identifier is associated with a loyalty program associated with the seller.

5. The computer of claim 2, wherein the seller can transmit the identifier, the data identifying the good or service, and the data identifying the seller without changes to the seller's hardware systems.

6. The computer of claim 1, further comprising a product information database, and wherein an item of product information from the product information database is posted to the social network.

7. The computer of claim 1, further comprising code to maintain metrics relating to the extent to which messages have influenced purchasing decisions.

8. The computer of claim 1, further comprising code to calculate statistics relating to the retail transaction.

9. A method of posting information comprising the steps of:
a. entering a code on a mobile device associated with a purchaser, wherein the code is associated with a good or service;
b. sending the code or information derived from the code to a platform server to determine whether a promotion for the good or service is active, said platform server comprising a database containing data relating to a social network account associated with the purchaser on a social network;
c. if a promotion for the good or service is active, displaying a message on the mobile device regarding the promotion
d. processing user input from the purchaser indicating a desire to purchase the good or service; and
e. using a social network account associated with the purchaser to post information about the purchaser, the transaction, and the good or service to a social network.

10. The method of claim 9, further comprising the step of providing an incentive for the purchase of the good or service.

11. The method of claim 9, wherein said entering step comprising scanning a code, and wherein said mobile device contains a scanner and executable code for performing the scan.

12. A method of posting information comprising the steps of:
a. requesting user input prior to checkout from an online transaction for a sale of a good or service, regarding whether a user has a type of identifier;
b. if the user does not have the type of identifier, activating a plug-in to connect to a platform server to create an identifier for the user;
c. if the user does have the type of identifier, activating the plug-in to authenticate the identifier with the platform server;
d. transmitting the identifier and data identifying the online transaction and the good or service to the platform server, said platform server comprising a database containing data relating to a social network account associated with the purchaser on a social network; and
e. using the social network account to transmit to the social network for display to others a message from the purchaser associating the online transaction with the purchaser, wherein the message includes information relating to at least one of the retail transaction and the good or service.

13. A method of posting information comprising the steps of:
a. displaying information on a computing device comprising information related to entities that a user may recommend and a reward for recommending an entity;
b. accepting user input indicating the user's consent to recommend the entity;
c. retrieving from a database at a platform server data relating to an account associated with the user on a social network; and
d. using the social network account to transmit to the social network for display to others a message from the purchaser recommending the entity.

14. A method of posting information comprising the steps of:
a. Displaying information on a computing device comprising information relating to an incentive to purchase a good or service;
b. accepting user input indicating the user's consent to purchase the good or service in exchange for the incentive;
c. processing the purchase of the good or service;
d. retrieving from a database at a platform server data relating to an account associated with the user on a social network;
e. using the social network account to transmit to the social network for display to others a message from the purchaser associating the online transaction with the purchaser, wherein the message includes information relating to at least one of the retail transaction and the good or service; and
f. transmitting a voucher to the user which entitles the user to obtain the good or service.

15. A method of posting information to a social network on behalf of a purchaser in a retail transaction with a seller for a good or service, comprising the steps of
a. receiving at a platform server an identifier belonging to the purchaser, said identifier having been sent to the platform server by a point of sale system or a retail server;
b. receiving the identity of the seller, the identity of the good or service and transaction information;
c. composing a social network posting to be posted on behalf of the purchaser, the posting containing the purchaser's identity, the identity of the seller, the identity of the good or service, and information relating to the retail transaction; and
d. using the purchaser's credentials on a social network to post the social network posting to the social network.
